(19) United States
(12) Patent Application Publication
(10) Pub. No.: US 2002/0072577 A1
(43) Pub. Date: Jun. 13, 2002

(54) Supported catalyst compositions

(75) Inventors: Grant B. Jacobsen, Bouc Bel Air (FR); Marc A. Springs, Angleton, TX (US); Lawrence D. Wilson, Lake Jackson, TX (US)

Correspondence Address: The Dow Chemical Company, 2301 N. Brazosport Blvd., B-1211, Freeport, TX, 77566, US

(73) Assignee: The Dow Chemical Company

(21) Appl. No.: 09/968,241

(22) Filed: Oct. 1, 2001

Related U.S. Application Data
(60) Provisional application No. 60/237,893, filed on Oct. 4, 2000.

(51) Int. Cl. C08F 4/44

(52) U.S. Cl. 526/129; 526/170; 526/160; 526/943; 526/352; 502/152

(57) ABSTRACT

The present invention relates to supported catalyst composition for an addition polymerization, a process to prepare the same and the use thereof in an addition polymerization, wherein the composition comprises: (A) a particulated, solid support material; (B) an activator which is an ammonium salt of a compatible, noncoordinating anion, A⁻, said anion, A⁻ containing a remnant formed by reaction of a non-ionic Lewis acid and a moiety containing an active hydrogen; and (C) a Group 4 metal complex catalyst.

### PRIOR RELATED APPLICATIONS

This application claims priority to prior U.S. Provisional Application Serial No. 60/237,893, filed Oct. 4, 2000, incorporated by reference herein in its entirety.

### FEDERALLY SPONSORED RESEARCH STATEMENT

Not applicable.

### REFERENCE TO MICROFICHE APPENDIX

Not applicable.

### FIELD OF THE INVENTION

The present invention relates to supported catalyst compositions that are particularly adapted for use in a polymerization process wherein at least one addition polymerizable monomer is contacted with the supported catalyst composition under polymerization conditions to form a polymeric product. The present invention further pertains to methods for making such supported catalyst compositions. The present invention further pertains to polymerization processes utilizing such supported catalyst compositions, particularly a gas-phase or slurry polymerization.

### BACKGROUND OF THE INVENTION

In U.S. Pat. Nos. 5,834,393 and 5,783,512 and WO 98/27119 the formation of supported catalyst compositions by deposition of ammonium salts of hydroxyphenyltris(pentafluorophenyl)borate or (dialkylaluminumoxyphenyl)tris-(pentafluorophenyl)borate, especially those salts wherein the ammonium cation contains one or more long chain aliphatic ligands, onto thermally dehydrated and metalhydrocarbyl, especially trialkylaluminum pretreated silica supports is disclosed.

Despite the satisfactory performance of the foregoing supported catalyst compositions under a variety of polymerization conditions, there is still a need for improved supported catalysts for use in the polymerization of various addition polymerizable monomers under a variety of reaction conditions. In particular, it is desired to prepare polymers of olefins in gas-phase and slurry polymerizations having improved polymer morphology. Moreover, in the production and handling of the above identified, previously known, supported catalyst compositions, a small but significant quantity of undersized, supported or non-supported, catalyst species (fines) may be formed. When employed in a gas-phase or slurry polymerization, the presence of such “fines” is believed to lead to formation of polymers having poor morphological properties.

It would be desirable if there were provided supported catalyst compositions comprising an ammonium salt of a (dialkylaluminumoxyphenyl)tris(pentafluoro-phenyl)borate or similar activator and a thermally dehydrated and a non-ionic Lewis acid-, especially a metalhydrocarbyl-, treated support that, when employed under use conditions in a slurry or gas phase polymerization, give polymer products having improved morphological properties.

### SUMMARY OF THE INVENTION

Accordingly, the subject invention provides a supported catalyst composition comprising:

A) a particulated, solid support material;

B) an activator which is an ammonium salt of a compatible, noncoordinating anion, A⁻, said anion, A⁻ containing a remnant formed by reaction of a non-ionic Lewis acid and a moiety containing an active hydrogen; and

C) a Group 4 metal complex catalyst,

characterized in that the support is prepared by thermally dehydrating a particulated, solid support material containing hydroxyl functionality on the surface thereof, or functionalized with a silane, sulfonic acid or hydroxyhydrocarbyl group and thereafter contacting the same with a non-ionic Lewis acid, in an amount from 0.9 to 2.0 moles of non-ionic Lewis acid per mole of hydroxyl, silane, chlorosilane, sulfonic acid and hydroxyhydrocarbyl functionality, and further characterized in that one or both of the following conditioning steps applies:

1) after preparation and before use as a polymerization catalyst, the supported catalyst composition is extracted by contact with an aliphatic, hydrocarbon liquid at a temperature from 30 to 120° C. so as to substantially remove extractable components therefrom, or

2) after preparation and before use as a polymerization catalyst, the supported catalyst composition is exposed to reduced pressure at a temperature from 25 to 100° C., while in a well agitated state, for a time sufficient to substantially remove volatile components therefrom.

In a preferred embodiment of the present invention both of the foregoing conditioning steps 1) and 2) are applied to the supported catalyst composition.

In addition, the subject invention provides a process for preparing a supported catalyst composition comprising:

A) thermally dehydrating a particulated, solid support material containing hydroxyl functionality on the surface thereof,

B) optionally functionalizing the support with silane, sulfonic acid or hydroxyhydrocarbyl groups;

C) contacting the thermally dehydrated particulated, solid support or functionalized derivative thereof with a non-ionic Lewis acid, in an amount from 0.9 to 2.0 moles of non-ionic Lewis acid per mole of hydroxyl, silane, chlorosilane, sulfonic acid and hydroxyhydrocarbyl functionality,

D) adding an activator which is an ammonium salt of a compatible, noncoordinating anion, A⁻, said anion, A⁻ containing a remnant formed by reaction of a non-ionic Lewis acid and a moiety containing an active hydrogen; and

E) adding a Group 4 metal complex catalyst,

characterized in that one or more of the following conditioning steps applies:

1) before use as a polymerization catalyst, the supported catalyst composition is extracted by contact with an aliphatic, hydrocarbon liquid at a temperature from 30 to 120° C. so as to substantially remove extractable components therefrom, or

2) before use as a polymerization catalyst, the supported catalyst composition is exposed to reduced pressure at a temperature from 25 to 80° C., while in a well agitated state, for a time sufficient to substantially remove volatile components therefrom.

Finally, the present invention provides a polymerization process comprising contacting one or more addition polymerizable monomers under gas phase or slurry polymerization conditions with a supported catalyst composition of the invention or prepared and conditioned by the foregoing process.

By treating the above supported catalyst compositions to the foregoing conditioning treatments, it is believed, without wishing to be bound by such belief, that undersized supported catalyst particles (fines) as well as unsupported catalyst species are removed from the bulk catalyst or prevented from formation, thereby generating a supported catalyst composition lacking in substantial quantities of undersized particle components or unsupported catalyst species.

### BRIEF DESCRIPTION OF THE DRAWINGS

Not Applicable.

### DESCRIPTION OF EMBODIMENTS OF THE INVENTION

All reference to the Periodic Table of the Elements herein shall refer to the Periodic Table of the Elements, published and copyrighted by CRC Press, Inc., 1999. Also, any reference to a Group or Groups shall be to the Group or Groups as reflected in this Periodic Table of the Elements using the IUPAC system for numbering groups. The contents of any patent, patent application or publication referenced herein is hereby incorporated by reference in its entirety for purposes of United States prosecution, especially with respect to its disclosure of organometallic structures, synthetic techniques and general knowledge in the art.

Preferred support materials for use herein are finely particulated materials that remain solids under conditions of preparation and use and that do not interfere with subsequent polymerizations or other uses of the composition of the invention. Suitable support materials especially include particulated metal oxides, oxides of silicon or germanium, polymers, and mixtures thereof. Examples include alumina, silica, aluminosilicates, clay, and particulated polyolefins. Particulated polymeric supports are preferably functionalized to provide hydroxyl, carboxylic acid or sulfonic acid reactive groups which are reacted with a non-ionic, Lewis acid as explained here-in-after to bear the corresponding oxy-, carboxy- or sulfoxy- linking group, joining the non-ionic Lewis acid remnant to the support. A preferred particulated, solid support material is silica. Suitable volume average particle sizes of the support are from 1 to 1000 μm, preferably from 10 to 100 μm.

The support material is thermally dehydrated, suitably by heating to 200 to 900° C. for from 10 minutes to 2 days, under an inert atmosphere or a vacuum. The support is desirably dehydrated in the foregoing manner prior to introducing the desired non-ionic Lewis acid functionality thereon. Optionally the support material may be functionalized by first treating it with a tri(C₁₋₁₀ alkyl)silylhalide, hexa(C₁₋₁₀ alkyl)disilazane, or similar reactive compound.

Functionalization with the non-ionic Lewis acid compound is accomplished by contacting the non-ionic Lewis acid reagent and the support. Examples of suitable non-ionic, Lewis acids for use in the preparation of the functionalized supports of the invention include hydrocarbylmetal, and halohydrocarbylmetal compounds, especially such compounds wherein the metal is a Group 2, 12 or 13 element, more especially trialkylaluminum and tri(haloalkyl)aluminum compounds, and mixtures of Lewis acids corresponding to the formula:

[(—AlQ¹—O—)_{z}(—AlAr^{f}—O—)_{z′}](Ar^{f}_{z″}Al₂Q¹_{6-z″})

where;

Q¹ independently each occurrence is selected from hydrocarbyl, hydrocarbyloxy, or dihydrocarbylamido, of from 1 to 20 atoms other than hydrogen;

Ar^{f} is a fluorinated aromatic hydrocarbyl moiety of from 6 to 30 carbon atoms;

z is a number from 1 to 50, preferably from 1.5 to 40, more preferably from 2 to 30, and the moiety (—AlQ¹—O—) is a cyclic or linear oligomer with a repeat unit of 2-30;

z′ is a number from 1 to 50, preferably from 1.5 to 40, more preferably from 2 to 30, and the moiety (—AlAr^{f}—O—) is a cyclic or linear oligomer with a repeat unit of 2-30; and

z″ is a number from 0 to 6, and the moiety (Ar^{f}_{z″}Al₂Q¹_{6-z″}) is either tri(fluoroarylaluminum), trialkylaluminum, a dialkylaluminumalkoxide, a dialkylaluminum(dialkylamide) or an adduct of tri(fluoroarylaluminum) with a sub-stoichiometric to super-stoichiometric amount of a trialkylaluminum.

The latter disclosed mixtures of non-ionic Lewis acids and adducts may be readily prepared by combining a tri(fluoroaryl)aluminum compound and an alkylaluminum compound, dialkylaluminumalkoxide, a dialkylaluminum(dialkylamide) an alumoxane, or mixture thereof. Such compositions have been previously disclosed in U.S. Pat. No. 5,602,269, WO00/09513 (published Feb. 4, 2000, equivalent to U.S. application Ser. No. 09/330671), WO00/09514 (published Feb. 4, 2000, equivalent to U.S. application Ser. No. 09/330675), WO00/09515 (published Feb. 4, 2000, equivalent to U.S. application Ser. No. 09/330673).

Preferred non-ionic Lewis acid reagents for use according to the present invention are trialkylaluminum compounds, or mixtures thereof, containing from 1 to 20 carbons in each alkyl group, most preferably trimethylaluminum, triethylaluminum, triisopropylaluminum, or triisobutylaluminum.

In a most preferred embodiment, thermally dehydrated silica is reacted with a Group 2, 12 or 13 metal alkyl, especially a tri(alkyl)aluminum, preferably a C₁₋₁₀ tri(alkyl)aluminum, most preferably, trimethylaluminum, triethylaluminum, triisopropylaluminum or triisobutylaluminum, to form a modified support. Optionally the support material may be first treated with a tri(C₁₋₁₀ alkyl)silylhalide, hexa(C₁₋₁₀ alkyl)disilazane, or similar reactive compound, to introduce the desired reactive functionality.

The amount of the non-ionic Lewis acid is chosen to pacify or react with from 50-100 percent of the reactive surface species, more preferably 90-100 percent, as determined by titration with Et₃Al. Titration with Et₃Al is defined as the maximum amount of aluminum that chemically reacts with the particulated solid support material and which cannot be removed by washing with an inert hydrocarbon.

The non-ionic Lewis acid and particulated support material may be combined and reacted in an aliphatic, alicyclic or aromatic liquid diluent, or solvent, or mixture thereof. Preferred diluents or solvents are C₄₋₁₀ hydrocarbons and mixtures thereof, including hexane, heptane, cyclohexane, and mixed fractions such as Isopar™E, available from Exxon Chemicals Inc. Preferred contacting times are at least one hour, preferably at least 90 minutes, at a temperature from 0 to 75° C., preferably from 20 to 50° C., most preferably from 25 to 35° C.

In a highly desirable embodiment of the invention, the support material is partially or fully evacuated to remove gasses from the pores thereof prior to contacting with the non-ionic Lewis acid. By first removing some or all of such gaseous substances, normally nitrogen or air, better contact with the entire surface area of the support material is obtained, by reducing bubbles that otherwise would occupy some of the available pore volume. In performing the foregoing evacuation process, a reduced pressure, preferably a pressure less than 90 percent of ambient, most preferably less than 85 percent of ambient is employed. The non-ionic Lewis acid is thereafter contacted with the support material prior to exposing the same to ambient pressure.

After contacting of the support and non-ionic Lewis acid, the reaction mixture may be purified to remove byproducts, by any suitable technique. Suitable techniques for removing byproducts from the reaction mixture include degassing, optionally at reduced pressures, distillation, solvent exchange, solvent extraction, extraction with a volatile agent, and combinations of the foregoing techniques, all of which are conducted according to conventional procedures. Preferably the quantity of residual byproduct is less than 10 weight percent, more preferably less than 1.0 weight percent, most preferably less than 0.1 weight percent, based on the weight of the functionalized catalyst support.

After the foregoing treatment, the supports preferably employed herein comprise a particulated inorganic oxide having a remnant of a non-ionic, Lewis acid activator functionality of the formula: —MeₘKₖ, on the surface thereof, wherein:

Me, is a Group 2, 12 or 13 metal, especially Al, bonded to the substrate, So,

K is an extractable or exchangeable, anionic ligand group, especially a hydrocarbyl or halohydrocarbyl group of up to 20 atoms, not counting hydrogen, and

m and k are selected to provide charge balance.

Highly desirably, the supports comprise a remnant of Lewis acid functionality generated by reaction of the non-ionic Lewis acid with reactive hydroxyl, hydroxyhydrocarbyl, silane or chlorosilane functionality of the thermally dehydrated substrate. It is believed that the non-ionic Lewis acid bonds to a hydroxyl, silane, chlorosilane, sulfonic acid or carboxylic acid functionality of the functionalized substrate, preferably by a ligand exchange mechanism, thereby generating an oxy-metal, oxy-metalloid, or silicon-metal containing linking group. Preferably, the linking group will be an oxygen-containing bridging moiety, more preferably the oxygen is contributed by the hydroxyl group of a thermally dehydrated silica support.

Suitable activators for use as component B) herein are trialkyl-ammonium- or dialkylarylammonium- salts of a compatible, noncoordinating anion, A⁻, containing a remnant formed by reaction of a non-ionic Lewis acid and a moiety containing an active hydrogen. Such compounds have been previously disclosed in U.S. Pat. Nos. 5,834,393 and 5,783,512, and elsewhere for use as an activator for a supported catalyst composition. As used herein, the term “noncoordinating” means an anion or substance which either does not coordinate to the Group 4 metal catalyst or the catalytic derivative derived therefrom, or which is only weakly coordinated to such complexes thereby remaining sufficiently labile to be displaced by a neutral Lewis base. A noncoordinating anion specifically refers to an anion which when functioning as a charge balancing anion in a cationic metal complex does not transfer an anionic substituent or fragment thereof to said cation thereby forming a neutral complex. “Compatible anions” are anions which are not degraded to neutrality when the initially formed complex decomposes and are noninterfering with subsequent polymerization or other use of the complex. The term “active hydrogen”, refers to a functionality capable of reacting with the non-ionic Lewis acid by transfer of a proton to a ligand of the Lewis acid, thereby forming an inert byproduct. Preferred active hydrogen groups include hydroxyl or thiol groups.

Preferably such activators may be represented by the following general formula:

(L*−H)_{d}⁺(A)^{d-}

wherein:

L* is a trihydrocarbylamine containing up to 80 carbons;

(L*−H)⁺ is a conjugate Bronsted acid of L*;

A^{d-} is a noncoordinating, compatible anion having a charge of d−, containing a remnant formed by reaction of a non-ionic, Lewis acid and a moiety containing an active hydrogen, and

d is an integer from 1 to 3.

More preferably A^{d-} corresponds to the formula: [DM′Q₃]⁻;

wherein:

M′ is boron or aluminum in the +3 formal oxidation state;

D is dialkylaluminoxyhydrocarbyl of up to 50 atoms not counting hydrogen, and

Q independently each occurrence is selected from hydride, dialkylamido, halide, hydrocarbyl, hydrocarbyloxide, halo-substituted hydrocarbyl, halo-substituted hydrocarbyloxy, and halo- substituted silylhydrocarbyl radicals (including perhalogenated hydrocarbyl-perhalogenated hydrocarbyloxy- and perhalogenated silylhydrocarbyl radicals), said Q having up to 20 carbons with the proviso that in not more than one occurrence is Q halide. Examples of suitable hydrocarbyloxide Q groups are disclosed in U.S. Pat. No. 5,296,433.

In a more preferred embodiment, d is one, that is, the counter ion has a single negative charge and is A⁻. Activating cocatalysts comprising boron which are particularly useful in the preparation of catalysts of this invention may be represented by the following general formula:

(L*−H)⁺(DBQ₃)⁻;

wherein:

L* is a trialkylamine or dialkylarylamine, having from 1 to 40 carbons in each alkyl or aryl group;

B is boron in a formal oxidation state of 3;

D is diethylaluminoxyphenyl, and

Q is a hydrocarbyl-, hydrocarbyloxy-, fluorohydrocarbyl-, fluorohydrocarbyloxy-, hydroxyfluorohydrocarbyl-, dihydrocarbylaluminum-oxyfluorohydrocarbyl-, or fluorinated silylhydrocarbyl- group of up to 20 nonhydrogen atoms, with the proviso that in not more than one occasion is Q hydrocarbyl. Most preferably, Q is each occurrence a fluorinated aryl group, especially, a pentafluorophenyl group.

Preferred ammonium salts are trialkyl-ammonium- or dialkylarylammonium- salts containing one or more C₁₀₋₄₀ alkyl groups. Most preferred ammonium cation containing salts are those containing trihydrocarbyl- substituted ammonium cations containing one or two C₁₀₋₄₀ alkyl groups, especially methylbis(octadecyl)-ammonium- and methylbis(tetradecyl)ammonium- cations. It is further understood that the cation may comprise a mixture of hydrocarbyl groups of differing lengths. For example, the protonated ammonium cation derived from the commercially available long chain amine comprising a mixture of two C₁₄, C₁₆ or C₁₈ alkyl groups and one methyl group. Such amines are available from Witco Corp., under the trade name Kemamine™ T9701, and from Akzo-Nobel under the trade name Armeen™ M2HT.

Illustrative, but not limiting, examples of boron compounds which may be used as an activating cocatalyst in the preparation of the improved catalysts of this invention (as well as previously known Group 4 metal catalysts) are

triethylammonium (diethylaluminoxyphenyl)tris(pentafluorophenyl) borate,

N,N-dimethylanilinium (diethylaluminoxyphenyl)tris(pentafluorophenyl) borate,

methylditetradecylammonium (diethylaluminoxyphenyl)tris(pentafluorophenyl) borate,

methyldioctadecylammonium (diethylaluminoxyphenyl)tris(pentafluorophenyl) borate,

phenyldioctadecylammonium (diethylaluminoxyphenyl)tris(pentafluorophenyl) borate,

(2,4,6-trimethylphenyl)dioctadecylammonium (diethylaluminoxyphenyl) tris(pentafluorophenyl)borate,

(2,4,6-trifluorophenyl)dioctadecylammonium (diethylaluminoxyphenyl)tris(pentafluorophenyl) borate,

(pentafluorophenyl)dioctadecylammonium (diethylaluminoxyphenyl)tris(pentafluorophenyl) borate,

(p-trifluoromethylphenyl)dioctadecylammonium (diethylaluminoxyphenyl)tris(pentafluorophenyl) borate,

p-nitrophenyldioctadecylammonium (diethylaluminoxyphenyl)tris(pentafluorophenyl) borate,

triethylammonium (ethoxyethylaluminoxyphenyl)tris(pentafluorophenyl) borate,

N,N-dimethylanilinium (ethoxyethylaluminoxyphenyl)tris(pentafluorophenyl) borate,

methylditetradecylammonium (ethoxyethylaluminoxyphenyl)tris(pentafluorophenyl) borate,

methyldioctadecylammonium (ethoxyethylaluminoxyphenyl)tris(pentafluorophenyl) borate,

phenyldioctadecylammonium (ethoxyethylaluminoxyphenyl)tris(pentafluorophenyl) borate,

(2,4,6-trimethylphenyl)dioctadecylammonium (ethoxyethylaluminoxyphenyl)tris(pentafluorophenyl) borate,

(2,4,6-trifluorophenyl)dioctadecylammonium (ethoxyethylaluminoxyphenyl)tris(pentafluorophenyl) borate,

(pentafluorophenyl)dioctadecylammonium (ethoxyethylaluminoxyphenyl)tris(pentafluorophenyl) borate,

(p-trifluoromethylphenyl)dioctadecylammonium (ethoxyethylaluminoxyphenyl)tris(pentafluorophenyl) borate,

p-nitrophenyldioctadecylammonium (ethoxyethylaluminoxyphenyl)tris(pentafluorophenyl) borate,

and mixtures of the foregoing.

The foregoing activators are relatively soluble in aromatic hydrocarbons but less soluble in aliphatic hydrocarbons. Thus they are contacted with the support material preferably by use of an aromatic hydrocarbon solution of the compounds. After contacting the support with such a solution, an aliphatic hydrocarbon can be introduced to the system, thereby causing precipitation of the activator compound onto the surface of the support material. Desirably in the foregoing technique for incorporating the activator component, the support is first exposed to reduced pressures to remove entrained gasses from the pores of the substrate, in a manner analogous to that preferably employed during the passivation treatment of the support using a non-ionic Lewis acid.

Suitable metal complexes for use a component C) herein include any complex of a metal of Groups 3-10 of the Periodic Table of the Elements capable of being activated to polymerize addition polymerizable compounds, especially olefins, by the present activator.

Suitable complexes include derivatives of Group 3, 4, or Lanthanide metals containing from 1 to 3 π-bonded anionic or neutral ligand groups, which may be cyclic or non-cyclic delocalized π-bonded anionic ligand groups. Exemplary of such π-bonded anionic ligand groups are conjugated or nonconjugated, cyclic or non-cyclic dienyl groups, allyl groups, boratabenzene groups, and arene groups. By the term “π-bonded” is meant that the ligand group is bonded to the transition metal by a sharing of electrons from a partially delocalized π-bond.

Each atom in the delocalized π-bonded group may independently be substituted with a radical selected from the group consisting of hydrogen, halogen, hydrocarbyl, halohydrocarbyl, hydrocarbyl-substituted metalloid radicals wherein the metalloid is selected from Group 14 of the Periodic Table of the Elements, and such hydrocarbyl- or hydrocarbyl-substituted metalloid radicals further substituted with a Group 15 or 16 hetero atom containing moiety. Included within the term “hydrocarbyl” are C₁₋₂₀ straight, branched and cyclic alkyl radicals, C₆₋₂₀ aromatic radicals, C₇₋₂₀ alkyl-substituted aromatic radicals, and C₇₋₂₀ aryl-substituted alkyl radicals. In addition two or more such radicals may together form a fused ring system, including partially or fully hydrogenated fused ring systems, or they may form a metallocycle with the metal. Suitable hydrocarbyl-substituted organometalloid radicals include mono-, di- and tri-substituted organometalloid radicals of Group 14 elements wherein each of the hydrocarbyl groups contains from 1 to 20 carbon atoms. Examples of suitable hydrocarbyl-substituted organometalloid radicals include trimethylsilyl, triethylsilyl, ethyldimethylsilyl, methyldiethylsilyl, triphenylgermyl, and trimethylgermyl groups. Examples of Group 15 or 16 hetero atom containing moieties include amine, phosphine, ether or thioether moieties or divalent derivatives thereof, e. g. amide, phosphide, ether or thioether groups bonded to the transition metal or Lanthanide metal, and bonded to the hydrocarbyl group or to the hydrocarbyl-substituted metalloid containing group.

Examples of suitable anionic, delocalized π-bonded groups include cyclopentadienyl, indenyl, fluorenyl, tetrahydroindenyl, tetrahydrofluorenyl, octahydrofluorenyl, pentadienyl, cyclohexadienyl, dihydroanthracenyl, hexahydroanthracenyl, decahydroanthracenyl groups, and boratabenzene groups, as well as C¹⁻¹⁰ hydrocarbyl-substituted or C₁₋₁₀ hydrocarbyl-substituted silyl substituted derivatives thereof. Preferred anionic delocalized π-bonded groups are cyclopentadienyl, pentamethylcyclopentadienyl, tetramethylcyclopentadienyl, tetramethylsilylcyclo-pentadienyl, indenyl, 2,3-dimethylindenyl, fluorenyl, 2-methylindenyl, 2-methyl-4-phenylindenyl, tetrahydrofluorenyl, octahydrofluorenyl, and tetrahydroindenyl.

Suitable metal complexes include Group 10 diimine derivatives corresponding to the formula:

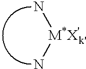

M* is Ni(II) or Pd(II);

X′ is halo, hydrocarbyl, or hydrocarbyloxy;

Ar* is an aryl group, especially 2,6-diisopropylphenyl or aniline group;

CT-CT is 1,2-ethanediyl, 2,3-butanediyl, or form a fused ring system wherein the two T groups together are a 1,8-naphthanediyl group; and

k′ is a number from 1 to 3 selected to provide charge balance.

Similar complexes to the foregoing are also disclosed by M. Brookhart, et al., in J. Am. Chem. Soc., 118, 267-268 (1996) and J. Am. Chem. Soc., 117, 6414-6415 (1995), as being active polymerization catalysts especially for polymerization of α-olefins, either alone or in combination with polar comonomers such as vinyl chloride, alkyl acrylates and alkyl methacrylates.

The boratabenzenes are anionic ligands which are boron containing analogues to benzene. They are previously known in the art having been described by G. Herberich, et al., in Organometallics, 1995, 14, 1, 471-480. Preferred boratabenzenes correspond to the formula:

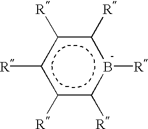

wherein R″ is selected from the group consisting of hydrocarbyl, silyl, or germyl, said R″ having up to 20 non-hydrogen atoms. In complexes involving divalent derivatives of such delocalized π-bonded groups one atom thereof is bonded by means of a covalent bond or a covalently bonded divalent group to another atom of the complex thereby forming a bridged system.

Phospholes are anionic ligands that are phosphorus-containing analogues to a cyclopentadienyl group. They are previously known in the art having been described by WO 98/50392, and elsewhere. Preferred phosphole ligands correspond to the formula:

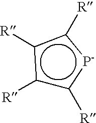

wherein R″ is as previously defined.

Suitable metal complexes for use in the catalysts of the present invention may be derivatives of any transition metal including Lanthanides, but preferably of Group 3, 4, or Lanthanide metals which are in the +2, +3, or +4 formal oxidation state meeting the previously mentioned requirements. Preferred compounds include metal complexes (metallocenes) containing from 1 to 3 π-bonded anionic ligand groups, which may be cyclic or noncyclic delocalized π-bonded anionic ligand groups. Exemplary of such π-bonded anionic ligand groups are conjugated or nonconjugated, cyclic or non-cyclic dienyl groups, allyl groups, and arene groups. By the term “π-bonded” is meant that the ligand group is bonded to the transition metal by means of delocalized electrons present in a π-bond.

More preferred are metal complexes corresponding to the formula:

L*ₗM′X′ₘX″ₚX′″_{q}, or a dimer thereof

wherein:

L* is an anionic, delocalized, π-bonded group that is bound to M, containing up to 50 atoms not counting hydrogen, optionally two L groups may be joined together through one or more substituents thereby forming a bridged structure, and further optionally one L* may be bound to X through one or more substituents of L*;

M′ is a metal of Group 4 of the Periodic Table of the Elements in the +2, +3 or +4 formal oxidation state;

X′ is a divalent substituent of up to 50 non-hydrogen atoms that together with L* forms a metallocycle with M′;

X″ is a neutral Lewis base having up to 20 non-hydrogen atoms;

X′″ is independently at each occurrence a monovalent, anionic moiety having up to 40 non-hydrogen atoms, optionally, two X′″ groups may be covalently bound together forming a divalent dianionic moiety having both valences bound to M′, or form a neutral, conjugated or nonconjugated diene that is π-bonded to M′ (whereupon M′ is in the +2 oxidation state), or further optionally one or more X′″ and one or more X″ groups may be bonded together thereby forming a moiety that is both covalently bound to M′ and coordinated thereto by means of Lewis base functionality;

l is 1 or 2;

m is 0 or 1;

p is a number from 0 to 3;

q is an integer from 0 to 3; and

the sum, l+m+q, is equal to the formal oxidation state of M′ except when X′″ groups form a neutral, conjugated or nonconjugated diene that is π-bonded to M′ (whereupon M′ is in the +2 oxidation state),.

Such preferred complexes include those containing either one or two L* groups. The latter complexes include those containing a bridging group linking the two L* groups. Preferred bridging groups are those corresponding to the formula (E*R*₂)ₓ wherein E* is silicon or carbon, R* independently each occurrence is hydrogen or a group selected from silyl, hydrocarbyl, hydrocarbyloxy and combinations thereof, said R* having up to 30 carbon or silicon atoms, and x is 1 to 8. Preferably, R* independently each occurrence is methyl, benzyl, tert-butyl or phenyl.

Preferred divalent X′ substituents preferably include groups containing up to 30 atoms not counting hydrogen and comprising at least one atom that is oxygen, sulfur, boron or a member of Group 14 of the Periodic Table of the Elements directly attached to the delocalized π-bonded group, and a different atom, selected from the group consisting of nitrogen, phosphorus, oxygen or sulfur that is covalently bonded to M′.

Examples of the foregoing bis(L*) containing complexes are compounds corresponding to the formula):

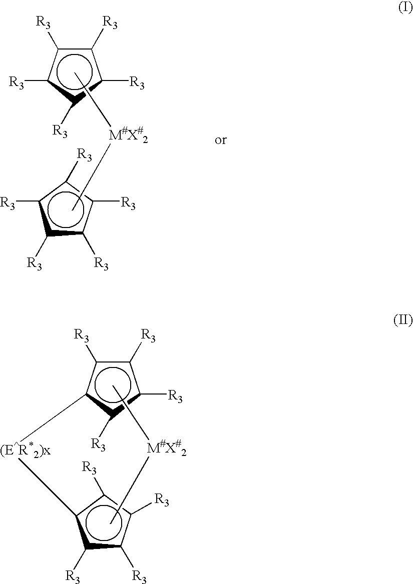

wherein:

M^{#} is titanium, zirconium or hafnium, preferably zirconium or hafnium, in the +2 or +4 formal oxidation state;

R³ in each occurrence independently is selected from the group consisting of hydrogen, hydrocarbyl, dihydrocarbylamino, hydrocarbyleneamino, silyl, trihydrocarbylsiloxy, hydrocarbyloxy, germyl, cyano, halo and combinations thereof, said R³ having up to 20 atoms not counting hydrogen, or adjacent R³ groups together form a divalent derivative thereby forming a fused ring system, and

X^{#} independently at each occurrence is an anionic ligand group of up to 40 atoms not counting hydrogen, or two X^{#} groups together form a divalent anionic ligand group of up to 40 atoms not counting hydrogen or together are a conjugated diene having from 4 to 30 atoms not counting hydrogen forming a π-complex with M^{#}, whereupon M^{#} is in the +2 formal oxidation state, and

(Eˆ R*₂)ₓ is as defined above.

The foregoing metal complexes are especially suited for the preparation of polymers having stereoregular molecular structure. In such capacity it is preferred that the complex possess C₂ symmetry or possess a chiral, stereorigid structure. Examples of the first type are compounds possessing different delocalized π-bonded systems, such as one cyclopentadienyl group and one fluorenyl group. Similar systems based on Ti(IV) or Zr(IV) were disclosed for preparation of syndiotactic olefin polymers in Ewen, et al., J. Am. Chem. Soc. 110, 6255-6256 (1980). Examples of chiral structures include bis-indenyl complexes. Similar systems based on Ti(IV) or Zr(IV) were disclosed for preparation of isotactic olefin polymers in Wild et al., J. Organomet. Chem, 232, 233-47, (1982).

Exemplary bridged ligands containing two π-bonded groups are: (dimethylsilyl-bis-cyclopentadienyl), (dimethylsilyl-bis-methylcyclopentadienyl), (dimethylsilyl-bis-ethylcyclopentadienyl), (dimethylsilyl-bis-t-butylcyclopentadienyl), (dimethylsilyl-bis-tetramethylcyclopentadienyl), (dimethylsilyl-bis-indenyl), (dimethylsilyl-bis-tetrahydroindenyl), (dimethylsilyl-bis-fluorenyl), (dimethylsilyl-bis-tetrahydrofluorenyl), (dimethylsilyl-bis-2-methyl-4-phenylindenyl), (dimethylsilyl-bis-2-methylindenyl), (dimethylsilyl-cyclopentadienyl-fluorenyl), (1,1,2,2-tetramethyl-1,2-disilyl-bis-cyclopentadienyl), (1,2-bis(cyclopentadienyl)ethane, and (isopropylidene-cyclopentadienyl-fluorenyl).

Preferred X^{#} groups are selected from hydride, hydrocarbyl, silyl, germyl, halohydrocarbyl, halosilyl, silylhydrocarbyl and aminohydrocarbyl groups, or two X^{#} groups together form a divalent derivative of a conjugated diene or else together they form a neutral, π-bonded, conjugated diene. Most preferred X^{#} groups are C₁₋₂₀ hydrocarbyl groups.

A preferred class of such Group 4 metal coordination complexes used according to the present invention correspond to the formula:

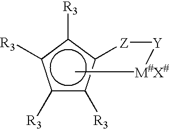

wherein:

M^{#}, X^{#} and R³ are as defined above,

Y is —O—, —S—, —NR*—, —PR*—; and

Z is SiR*₂, CR*₂, SiR*₂SiR*₂, CR*₂CR*₂, CR*═CR*, CR*₂SiR*₂, BNR*₂, or GeR*₂,

wherein R* is as defined above.

Illustrative Group 4 metal complexes that may be employed in the practice of the present invention include:

cyclopentadienyltitaniumtrimethyl,

cyclopentadienyltitaniumtriethyl,

cyclopentadienyltitaniumtriisopropyl,

cyclopentadienyltitaniumtriphenyl,

cyclopentadienyltitaniumtribenzyl,

cyclopentadienyltitanium-2,4-dimethyl pentadienyl,

cyclopentadienyltitaniumdimethylmethoxide,

cyclopentadienyltitaniumdimethylchloride,

pentamethylcyclopentadienyltitaniumtrimethyl,

indenyltitaniumtrimethyl,

indenyltitaniumtriethyl,

indenyltitaniumtripropyl,

indenyltitaniumtriphenyl,

tetrahydroindenyltitaniumtribenzyl,

pentamethylcyclopentadienyltitaniumtriisopropyl,

pentamethylcyclopentadienyltitaniumtribenzyl,

pentamethylcyclopentadienyltitaniumdimethylmethoxide,

(η⁵-2,4-dimethyl-1,3-pentadienyl)titaniumtrimethyl,

octahydrofluorenyltitaniumtrimethyl,

tetrahydroindenyltitaniumtrimethyl,

tetrabydrofluorenyltitaniumtrimethyl,

(1,1-dimethyl-2,3,4,9,10-(-1,4,5,6,7,8-hexahydronaphthalenyl)titaniumtrimethyl,

(1,1,2,3-tetramethyl-2,3,4,9,10-(-1,4,5,6,7,8-hexahydronaphthalenyl)titaniumtrimethyl,

(tert-butylamido)(tetramethyl-η⁵-cyclopentadienyl)dimethylsilanetitanium dimethyl,

(tert-butylamido)(tetramethyl-η⁵-cyclopentadienyl)-1,2-ethanediyltitanium dimethyl,

(tert-butylamido)(hexamethyl-η⁵-indenyl)dimethylsilanetitanium dimethyl,

(tert-butylamido)(tetramethyl-η⁵-cyclopentadienyl)dimethylsilane titanium (III) 2-(dimethylamino)benzyl;

(tert-butylamido)(tetramethyl-η⁵-cyclopentadienyl)dimethylsilanetitanium (III) allyl,

(tert-butylamido)(tetramethyl-η⁵cyclopentadienyl)dimethylsilanetitanium (II) 1,4-diphenyl-1,3-butadiene,

(tert-butylamido)(2-methylindenyl)dimethylsilanetitanium (II) 1,4-diphenyl-1,3-butadiene,

(tert-butylamido)(2-methylindenyl)dimethylsilanetitanium (IV) 1,3-butadiene,

(tert-butylamido)(2,3-dimethylindenyl)dimethylsilanetitanium (II) 1,4-diphenyl-1,3-butadiene,

(tert-butylamido)(2,3-dimethylindenyl)dimethylsilanetitanium (IV) 1,3-butadiene,

(tert-butylamido)(2,3-dimethylindenyl)dimethylsilanetitanium (II) 1,3-pentadiene,

(tert-butylamido)(2-methylindenyl)dimethylsilanetitanium (II) 1,3-pentadiene,

(tert-butylamido)(2-methylindenyl)dimethylsilanetitanium (IV) dimethyl,

(tert-butylamido)(2-methyl-4-phenylindenyl)dimethylsilanetitanium (II)1,4-diphenyl-1,3-butadiene,

(tert-butylamido)(tetramethyl-η⁵-cyclopentadienyl )dimethylsilanetitanium (IV) 1,3-butadiene,

(tert-butylamido)(tetramethyl-η⁵cyclopentadienyl)dimethylsilanetitanium (II) 1,4-dibenzyl-1,3-butadiene,

(tert-butylamido)(tetramethyl-η⁵-cyclopentadienyl)dimethylsilanetitanium (II) 2,4-hexadiene,

(tert-butylamido)(tetramethyl-η⁵-cyclopentadienyl)dimethylsilanetitanium (II) 3-methyl 1,3-pentadiene,

(tert-butylamido)(4,4-dimethyl-1 cyclohexadienyl)dimethylsilanetitaniumdimethyl,

(tert-butylamido)(1,1-dimethyl-2,3,4,9,10-(-1,4,5,6,7,8-hexahydronaphthalen-4-yl) dimethylsilanetitaniumdimethyl,

(tert-butylamido)(1,1,2,3-tetramethyl-2,3,4,9,10-(η-1,4,5,6,7,8-hexahydronaphthalen-4-yl) dimethylsilanetitaniumdimethyl,

(tert-butylamido)(tetramethylcyclopentadienyl)dimethylsilanetitanium 1,3-pentadiene,

(tert-butylamido)(3-(N-pyrrolidinyl)inden-1-yl)dimethylsilanetitanium 1,3-pentadiene,

(tert-butylamido)(2-methyl-s-indacen-1-yl)dimethylsilanetitanium 1,3-pentadiene, and

(tert-butylamido)(3,4-cyclopenta(l)phenanthren-2-yl)dimethylsilanetitanium 1,4-diphenyl-1,3-butadiene.

Bis(L*)-containing complexes including bridged complexes suitable for use in the present invention include:

biscyclopentadienylzirconiumdimethyl,

biscyclopentadienylzirconiumdiethyl,

biscyclopentadienylzirconiumdiisopropyl,

biscyclopentadienylzirconiumdiphenyl,

biscyclopentadienylzirconium dibenzyl,

biscyclopentadienylzirconium-diallyl,

biscyclopentadienylzirconiummethylmethoxide,

bispentamethylcyclopentadienylzirconiumdimethyl,

bisindenylzirconiumdimethyl,

indenylfluorenylzirconiumdiethyl,

bisindenylzirconiumnmethyl(2-(dimethylamino)benzyl),

bisindenylzirconium methyltrimethylsilyl,

bistetrahydroindenylzirconium bis(rimethylsilylmethyl),

bispentamethylcyclopentadienylzirconiumdiisopropyl,

bispentamethylcyclopentadienylzirconiumdibenzyl,

bispentamethylcyclopentadienylzirconiummethylmethoxide,

(dimethylsilyl-bis-cyclopentadienyl)zirconiumdimethyl,

(dimethylsilyl-bis-tetramethylcyclopentadienyl)zirconiumdiallyl,

(methylene-bis-tetramethylcyclopentadienyl)zirconiumbis(2-dimethylaminobenzyl),

(dimethylsilyl-bis-2-methylindenyl)zirconiumdimethyl,

(dimethylsilyl-bis-2-methyl-4-phenylindenyl)zirconiumdimethyl,

(dimethylsilyl-bis-2-methylindenyl)zirconium-1,4-diphenyl-1,3-butadiene,

(dimethylsilyl-bis-2-methyl-4-phenylindenyl)zirconium (II) 1,4-diphenyl-1,3-butadiene,

(dimethylsilyl-bis-tetrahydroindenyl)zirconium(II) 1,4-diphenyl-1,3-butadiene,

(dimethylsilyl-bis-tetrahydrofluorenyl)zirconiumdi(trimethylsilylmethyl),

(isopropylidene)(cyclopentadienyl)(fluorenyl)zirconiumdibenzyl, and

(dimethylsilyltetramethylcyclopentadienylfluorenyl)zirconiumdimethyl.

Other metal compounds that are useful in the preparation of the supported catalyst compositions according to this invention, especially compounds containing other Group 4 metals, will be apparent to those skilled in the art.

The metal complex and activator treated support are suitably contacted under conditions to cause deposition of the metal complex onto the surface of the support. When prepared in the foregoing manner, the catalyst components, especially the anion of the ammonium salt activator is relatively insoluble in aliphatic solvents and remains substantially immobilized on the surface of the support. The metal complex likewise remains relatively fixed to the support due to an electronic interaction with the anion of the ammonium salt activator.

The molar ratio of metal complex/activator employed preferably ranges from 1:10 to 10:1, more preferably from 1:1 to 1:2 most preferably from 1:1 to 1:1.5. The amount of metal complex used per gram of final support is desirably from 0.1 μmole to 1 mmole, preferably from 1 μmole to 100 μmole. In most polymerization reactions the molar ratio of metal complex: polymerizable compound employed is from 10⁻¹²:1 to 10⁻¹:1, more preferably from 10⁻¹²:1 to 10⁻⁵:1.

Any suitable means for contacting the metal complex and support may be used, including dispersing or dissolving the metal complex in a liquid, preferably a hydrocarbon, more preferably an aliphatic, liquid hydrocarbon, and contacting the mixture or solution with the support by slurrying, impregnating, spraying, or coating and thereafter removing the liquid, or by combining the metal complex and support material in dry or paste form and intimately contacting the mixture, thereafter forming a dried, particulated product. As in previous treatments of the solid support, a solution of the metal complex in an aliphatic hydrocarbon is desirably employed, and the support is desirably evacuated prior to such contact in order to assist incorporation of the metal complex into the pores of the support.

After preparation of the supported catalyst composition, it may be extracted by exposure to an aliphatic or cycloaliphatic hydrocarbon or hydrocarbon mixture, at a temperature from 30 to 120° C., more preferably from 30 to 100° C., most preferably from 30 to 70° C.. The composition may be extracted in a single stage, in multiple stages or continuously. The foregoing extraction procedure may be conducted after first washing the composition with one or more courses of a liquid, including the same aliphatic or cycloaliphatic hydrocarbon or hydrocarbon mixture employed in the extraction, said washing step being conducted, however, at a temperature less than 30° C.. Preferably, hexane, 2-methylpentane, cyclohexane or a mixture thereof is employed as the extracting medium. Elevated pressures may be utilized during the extraction if desired, especially in order to retain the extractant in the liquid state.

As an alternative to the foregoing extraction process, or in addition thereto, the composition of the invention may also be devolatilized by exposure to reduced pressure at a temperature from 25 to 100° C., preferably 25 to 70° C., while in a well agitated state, for a time sufficient to substantially remove volatile components therefrom. Preferred supported catalyst compositions of the invention have a residual volatile component content of less than 0.7 percent, more preferably less than 0.5 percent. Preferably the devolatilization is conducted at pressures less than 2 kPa, more preferably less than 1.5 kPa, most preferably less than 1.0 kPa. During the devolatilization, the supported catalyst composition is sufficiently agitated to cause through intermingling of the catalyst particles, and homogeneous exposure of the catalyst particles to the reduced pressure, ambient conditions of the devolatilization. Desirably, the agitation is sufficient, to attain a Froude number in the devolatilization vessel of from 0.1 to 10. Froude Number, as used herein, is a measure of the degree of agitation of a confined particulated medium. The unit of measurement is defined in McCabe and Smith, Unit Operations of Chemical Engineering, Third, Ed., pp 236-237, equations 9-17, McGraw Hill (1976). At lower Froude Numbers, the degree of agitation of the devolatilization vessel is insufficient for optimal results. At higher Froude numbers, excess energy is consumed in the process and it is liable to become inefficient. Moreover, fragmentation of the substrate may occur thereby generating additional amounts of undesired, undersized particles.

In addition to application of agitation during the foregoing devolatilization process, a similar agitation procedure can also be applied during preparation of the support or supported catalyst so as to incorporate one of the foregoing components B) or C) or at any stage where drying the same under reduced pressure is desired. For example, it is especially desirably to employ such agitation during any drying step immediately after treatment of the thermally dehydrated support with the non-ionic Lewis acid, as well as during the application of the various components or conditioning treatments.

Suitable polymerizable monomers that may be polymerized using the supported catalysts compounds of the invention include ethylenically unsaturated monomers, acetylenic compounds, conjugated or non-conjugated dienes, and polyenes. Preferred monomers include olefins, for examples alpha-olefins having from 2 to 20,000, preferably from 2 to 20, more preferably from 2 to 8 carbon atoms and combinations of two or more of such alpha-olefins. Particularly suitable alpha-olefins include, for example, ethylene, propylene, 1-butene, 1-pentene, 4-methylpentene-1, 1-hexene, 1-heptene, 1-octene, 1-nonene, 1-decene, 1-undecene, 1-dodecene, 1-tridecene, 1-tetradecene, 1-pentadecene, or combinations thereof, as well as long chain vinyl terminated oligomeric or polymeric reaction products formed during the polymerization, and C₁₀₋₃₀ α-olefins specifically added to the reaction mixture in order to produce relatively long chain branches in the resulting polymers. Preferably, the alpha-olefins are ethylene, propene, 1-butene, 4-methyl-pentene-1, 1-hexene, 1 -octene, and combinations of ethylene and/or propene with one or more of such other alpha-olefins. Other preferred monomers include styrene, halo- or alkyl substituted styrenes, tetrafluoroethylene, vinylcyclobutene, 1,4-hexadiene, dicyclopentadiene, ethylidene norbomene, and 1,7-octadiene. Mixtures of the above-mentioned monomers may also be employed.

In general, the polymerization may be accomplished at conditions well known in the prior art for Ziegler-Natta or Kaminsky-Sinn type polymerization reactions conducted under slurry or gas phase polymerization conditions. Preferred polymerization temperatures are from 0-250° C. Preferred polymerization pressures are from atmospheric to 3000 atmospheres (300 MPa).

Molecular weight control agents can be used in combination with the present cocatalysts. Examples of such molecular weight control agents include hydrogen, silanes or other known chain transfer agents. Modifiers, such as Lewis base compounds, can be added to the polymerization, to slow the initial polymerization rate, especially in a gas-phase polymerization, in order to prevent localized overheating of the catalyst. Such, modifiers provide a longer lasting catalyst composition and more uniform catalyst and polymer product composition.

Gas phase processes for the polymerization of C₂₋₆ olefins, especially the homopolymerization and copolymerization of ethylene and propylene, and the copolymerization of ethylene with C₃₋₆ α-olefins such as, for example, 1-butene, 1-hexene, 4-methyl-1-pentene are well known in the art. Such processes are used commercially on a large scale for the manufacture of high density polyethylene (HDPE), medium density polyethylene (MDPE), linear low density polyethylene (LLDPE) and polypropylene, especially isotactic polypropylene.

The gas phase process employed can be, for example, of the type which employs a mechanically stirred bed or a gas fluidized bed as the polymerization reaction zone. Preferred is the process wherein the polymerization reaction is carried out in a vertical cylindrical polymerization reactor containing a fluidized bed of polymer particles supported above a perforated plate, the fluidization grid, by a flow of fluidization gas.

The gas employed to fluidize the bed comprises the monomer or monomers to be polymerized, and also serves as a heat exchange medium to remove the heat of reaction from the bed. The hot gases emerge from the top of the reactor, normally via a tranquilization zone, also known as a velocity reduction zone, having a wider diameter than the fluidized bed and wherein fine particles entrained in the gas stream have an opportunity to gravitate back into the bed. It can also be advantageous to use a cyclone to remove ultra-fine particles from the hot gas stream. The gas is then normally recycled to the bed by means of a blower or compressor and one or more heat exchangers to strip the gas of the heat of polymerization.

A preferred method of cooling of the bed, in addition to the cooling provided by the cooled recycle gas, is to feed a volatile liquid to the bed to provide an evaporative cooling effect. The volatile liquid employed in this case can be, for example, a volatile inert liquid, for example, a saturated hydrocarbon having 3 to 8, preferably 4 to 6, carbon atoms. In the case that the monomer or comonomer itself is a volatile liquid, or can be condensed to provide such a liquid this can be suitably be fed to the bed to provide an evaporative cooling effect. Examples of olefin monomers which can be employed in this manner are olefins containing from 3 to eight, preferably from 3 to six carbon atoms. The volatile liquid evaporates in the hot fluidized bed to form gas which mixes with the fluidizing gas. If the volatile liquid is a monomer or comonomer, it will undergo some polymerization in the bed. The evaporated liquid then emerges from the reactor as part of the hot recycle gas, and enters the compression/heat exchange part of the recycle loop. The recycle gas is cooled in the heat exchanger and, if the temperature to which the gas is cooled is below the dew point, liquid will precipitate from the gas. This liquid is desirably recycled continuously to the fluidized bed. It is possible to recycle the precipitated liquid to the bed as liquid droplets carried in the recycle gas stream, as described, for example, in EP-A-89691, U.S. Pat. No. 4,543,399, WO 94/25495 and U.S. Pat. No. 5,352,749. A particularly preferred method of recycling the liquid to the bed is to separate the liquid from the recycle gas stream and to reinject this liquid directly into the bed, preferably using a method which generates fine droplets of the liquid within the bed. This type of process is described in WO 94/28032.

The polymerization reaction occurring in the gas fluidized bed is catalyzed by the continuous or semi-continuous addition of catalyst. The catalyst can also be subjected to a prepolymerization step, for example, by polymerizing a small quantity of olefin monomer in a liquid inert diluent, to provide a catalyst composite comprising catalyst particles embedded in olefin polymer particles.

The polymer is produced directly in the fluidized bed by catalyzed (co)polymerization of the monomer(s) on the fluidized particles of polymer, supported catalyst, or prepolymer within the bed. Start-up of the polymerization reaction is achieved using a bed of preformed polymer particles, which, preferably, is similar to the target polyolefin, and conditioning the bed by drying with inert gas or nitrogen prior to introducing the catalyst, the monomer(s) and any other gases which it is desired to have in the recycle gas stream, such as a diluent gas, hydrogen chain transfer agent, or an inert condensable gas when operating in gas phase condensing mode. An antistatic agent, such as Stadis™ hydrocarbon based antistatic agent (available from DuPont Chemicals) may be included in the reaction mixture to prevent polymer agglomerate formation according to known techniques as well. The produced polymer is discharged continuously or discontinuously from the fluidized bed as desired, optionally exposed to a catalyst kill and optionally pelletized.

Supported catalysts for use in slurry polymerization may be used according to previously known techniques. Generally such catalysts are prepared by the same techniques as are employed for making supported catalysts used in gas phase polymerizations. Slurry polymerization conditions generally encompass polymerization of a C₂₋₂₀ olefin, diolefin, cycloolefin, or mixture thereof in an aliphatic solvent at a temperature below that at which the polymer is readily soluble in the presence of a supported catalyst. Slurry phase processes particularly suited for the polymerization of C₂₋₆ olefins, especially the homopolymerization and copolymerization of ethylene and propylene, and the copolymerization of ethylene with C₃₋₈ α-olefins such as, for example, 1-butene, 1-hexene, 4-methyl-1-pentene and 1-octene are well known in the art. Such processes are used commercially on a large scale for the manufacture of high density polyethylene (HDPE), medium density polyethylene (MDPE), linear low density polyethylene (LLDPE) and polypropylene, especially isotactic polypropylene.

It is understood that the present invention is operable in the absence of any component that has not been specifically disclosed. The following examples are provided in order to further illustrate the invention and are not to be construed as limiting. Unless stated to the contrary, all parts and percentages are expressed on a weight basis. Where stated the term “room temperature” refers to a temperature from 20 to 25° C., the term “overnight” refers to a time from 12 to 18 hours, and the term “mixed alkanes” refers to the aliphatic solvent, Isopar™ E, available from Exxon Chemicals Inc. All solvents were purified using the technique disclosed by Pangborn et al, Organometallics, 1996, 15, 1518-1520. All compounds and solutions were handled under an inert atmosphere (dry box). (t-Butylamido)dimethyl(tetramethyl-cyclopentadienyl)titanium 1,3-pentadiene was prepared substantially according to the procedure of U.S. Pat. No. 6,015,916.

### EXAMPLE 1

Silica (Grace-Davison 948, available from the Grace-Davison division of W. R. Grace & Co.) was dehydrated at 250° C. for 3 hours in nitrogen. Then, the silica was evacuated by exposure to a reduced pressure of about 500 torr (70 kPa), contacted with hexane (sufficient to thoroughly wet the silica), and the resulting mixture treated with a 1.00 M solution of triethylaluminum (TEA) in hexane in an amount to provide 2.2 mmol TEA/g silica. The mixture was agitated for 30 minutes and then the solids were washed repeatedly with hexane until the quantity of aluminum species in the elutant was less than 0.005 M. The resulting product was dried under reduced pressure to a residual solvent level of less than 1.0 percent. Because more than a stoichiometric amount of triethylaluminum compared to the quantity of reactive sites on the silica was employed, the resulting material had substantially no residual hydroxyl functionality remaining on the surface of the silica.

The above TEA treated silica was placed in a rotary dryer equipped with a spray nozzle adjusted to provide a finely atomized liquid spray and operating at a partially reduced pressure of about 500 torr (70 kPa) (model DVT-800, manufactured by Littleford Day, incorporated, Cincinnati, Ohio, USA). A 10 weight percent toluene solution of activator formed by reaction of methyldi(C₁₄₋₁₈H₂₉₋₃₇) ammonium hydroxyphenyltris(pentafluoro-phenyl)borate with 1.1 molar equivalents of triethylaluminum was added by atomizing a fine stream thereof into a well agitated mixture of the support over approximately 30 minutes at about 20° C. and 70 kPa of pressure. The mixture was allowed to mix an additional 1 hour at the same temperature and pressure.

Excess hexane was added to the stirred mixture thereby forming a slurry, which was allowed to agitate for 30 minutes. (t-Butylamido)dimethyl(tetramethyl-cyclopentadienyl)titanium 1,3-pentadiene (about 10 percent by weight in heptane) was added to provide a weight ratio of catalyst: support of about 1:65. The mixture was agitated for an additional 2 hours and allowed to return to ambient pressure. The slurry was filtered and washed with excess hexane four times. The resulting supported catalyst was dried at 30° C. for about 30 minutes under dynamic vacuum of 90 kPa (agitated devolatilization), while being agitated sufficiently to attain a Froude number of about 0.2. The resulting supported catalyst had a residual solvent level less than about 0.5 percent.

### EXAMPLE 2

The preparation of Example 1 was substantially repeated excepting that after the agitated devolatilization the supported catalyst composition was subjected to continuous extraction with refluxing hexane for a period of 4 hours. The product was dried to a residual solvent level less than about 0.5 percent by exposure to reduced pressure of 90 kPa for 1 hour, while gently agitating the bulk material.

### EXAMPLE 3

The preparation of Example 1 was substantially repeated excepting that instead of the agitated devolatilization, the supported catalyst composition was subjected to continuous extraction with refluxing hexane for a period of 4 hours.

### COMPARATIVE EXAMPLE A

The preparation of Example 1 was substantially repeated excepting that the additions of non-ionic Lewis acid and activator were performed at substantially atmospheric pressure under conditions of gentle agitation and the final product was dried to a residual solvent level less than about 0.5 percent by exposure to reduced pressure of 90 kPa for 1 hour while gently agitating the bulk material.

### Slurry Phase Polymerization

A stirred 4.0 L reactor was charged with 1800 g of hexane and heated to the reaction temperature of 70° C. Ethylene was added to the reactor in an amount sufficient to bring the total pressure to the desired operating level of 1.3 MPa (190 psi). 0.30 g Of catalyst from Example 1 was then added to the reactor using nitrogen pressure. The reactor pressure was kept essentially constant by continually feeding ethylene on demand during the polymerization run while maintaining the reactor temperature at 70° C. with a cooling jacket. After 60 minutes, the ethylene flow was discontinued, the reactor was vented, and the contents of the reactor were filtered to isolate the powdered polymeric product. The powder was dried in a vacuum oven to yield 352 g of free flowing polyethylene powder.

The reaction conditions were substantially repeated using the catalyst composition of comparative example A. After a reaction period of 30 minutes, 0.50 g of catalyst yielded 500 g of free flowing polyethylene powder.

The polymer product produced using the supported catalyst composition of Example 1 has a relatively uniform, monomodal particle size with a median particle size (determined by laser diffraction) falling at approximately 800 μm. In contrast, the polymer product made using the supported catalyst composition of Comparative A had a bimodal particle size distribution with a major particle node centered at about 700 μm and a minor node centered at about 90 μm, signifying production of a significant quantity of undesirable, undersized polymer particles (fines).

### Gas Phase Polymerization

A 2.5-L stirred, fixed bed autoclave was charged with 300 g dry NaCl. Stirring was begun at 300 rpm. The reactor was pressurized to 0.7 MPa ethylene and heated to 70° C.. 1-Hexene (6000 ppm) and hydrogen (2200 ppm) were introduced to the reactor. About 0.5 g of TEA treated silica was added to the reactor as a scavenger. In a separate vessel, 0.075 g of the supported catalyst composition of Example 1 was mixed with an additional 0.5 g of TEA treated silica scavenger. The combined catalyst and scavenger were subsequently injected into the reactor. Ethylene pressure was maintained on demand while 1-hexene was fed to the reactor to maintain the desired concentration. The temperature of the reactor was maintained at 70° C. by a circulating water bath. After 90 minutes the reactor was depressurized, and the salt and polymer were removed. The polymer was washed with copious quantities of distilled water to remove the salt, dried at 50° C., and stabilized by addition of a hindered phenol antioxidant (Irganox™ 1010 from Ciba Geigy Corporation) and a phosphorus stabilizer. Yield was approximately 50 g of ethylene/hexene copolymer.

The reaction conditions were substantially repeated using the supported catalyst composition of Example 2. Using Example 1, the initial exotherrn experienced during the polymerization was 31.0° C., the initial activity was 12.0 Kg/g·hr·MPa, and the average activity was 1.45 Kg/g·hr·MPa. Using the supported catalyst composition of Example 2 the comparable values were: 15.7° C., 7.8 Kg/g·hr·MPa, and 1.39 Kg/g·hr·MPa, respectively. This substantially moderated initial exotherm and activity indicates that the reaction profile of the supported catalyst of Example 2 has been improved, resulting in greater uniformity of performance over the catalyst lifetime.

What is claimed is:

1. A supported catalyst composition comprising:
A) a particulated, solid support material;
B) an activator which is an ammonium salt of a compatible, noncoordinating anion, A⁻, said anion, A⁻ containing a remnant formed by reaction of a non-ionic Lewis acid and a moiety containing an active hydrogen; and
C) a Group 4 metal complex catalyst,
characterized in that the support is prepared by thermally dehydrating a particulated, solid support material containing hydroxyl functionality on the surface thereof, or functionalized with a silane, sulfonic acid or hydroxyhydrocarbyl group and thereafter contacting the same with a non-ionic Lewis acid, in an amount from 0.9 to 2.0 moles of non-ionic Lewis acid per mole of hydroxyl, silane, chlorosilane, sulfonic acid and hydroxyhydrocarbyl functionality, and further characterized in that one or both of the following conditioning steps applies:
1) after preparation and before use as a polymerization catalyst, the supported catalyst composition is extracted by contact with an aliphatic, hydrocarbon liquid at a temperature from 30 to 120° C. so as to substantially remove extractable components therefrom, or
2) after preparation and before use as a polymerization catalyst, the supported catalyst composition is exposed to reduced pressure at a temperature from 25 to 100° C., while in a well agitated state, for a time sufficient to substantially remove volatile components therefrom.

2. A composition according to claim 1 wherein the support comprises a particulated inorganic oxide having a remnant of a non-ionic, Lewis acid activator functionality of the formula: —MeₘKₖ, on the surface thereof, wherein:
Me, is a Group 2, 12 or 13 metal, especially Al, bonded to the substrate, So,
K is an extractable or exchangeable, anionic ligand group, especially a hydrocarbyl or halohydrocarbyl group of up to 20 atoms, not counting hydrogen, and
m and k are selected to provide charge balance.

3. A composition according to claim 2 wherein the support is silica.

4. A composition according to claim 3, wherein the activator is a compound of the formula: (L*−H)⁺(DBQ₃)⁻;
wherein:
L* is a trialkylamine or dialkylarylamine, having from 1 to 40 carbons in each alkyl or aryl group;
B is boron in a formal oxidation state of 3;
D is diethylaluminoxyphenyl, and
Q is a hydrocarbyl-, hydrocarbyloxy-, fluorohydrocarbyl-, fluorohydrocarbyloxy-, hydroxyfluorohydrocarbyl-, dihydrocarbylaluminum-oxyfluorohydrocarbyl-, or fluorinated silylbydrocarbyl- group of up to 20 nonhydrogen atoms, with the proviso that in not more than one occasion is Q hydrocarbyl.

5. A supported catalyst composition according to claim 4, wherein Q each occurrence is pentafluorophenyl.

6. A supported catalyst composition according to claim 5, wherein the Group 3-10 metal complex contains at least one π-bonded anionic ligand group which is a conjugated or non-conjugated, cyclic or non-cyclic dienyl group, an allyl group, aryl group, or a substituted derivative thereof.

7. A supported catalyst composition according to claim 6, wherein the π-bonded anionic ligand group is a cyclopentadienyl group or a derivative thereof.

8. A supported catalyst composition according to claims 1, 2, 3, 4, 5, 6, or 7 wherein in the preparation thereof, the non-ionic Lewis acid, activator component B) or catalyst component C) are incorporated therein by contacting the non-ionic Lewis acid, activator component B) or catalyst component C) with the substrate material which has been evacuated to remove or partially remove gaseous substances from the pores thereof.

9. A polymerization process comprising contacting one or more addition polymerizable monomers under gas phase or slurry polymerization conditions with a catalyst composition according to claims 1, 2, 3, 4, 5, 6, or 7.

10. A polymerization process comprising contacting one or more addition polymerizable monomers under gas phase or slurry polymerization conditions with a catalyst composition according to claim 8.

11. A process according to claim 9, wherein ethylene is polymerized, optionally with one or more comonomers to form an ethylene homopolymer or copolymer.

12. A process according to claim 10, wherein ethylene is polymerized, optionally with one or more comonomers to form an ethylene homopolymer or copolymer.
